(19) United States
(12) Patent Application Publication
(10) Pub. No.: US 2002/0161853 A1
(43) Pub. Date: Oct. 31, 2002

(54) Real-time financial charting system

(76) Inventors: Alp Burak, Singapore (SG); Allen Yeong, Singapore (SG)

Correspondence Address: Mark D. Saralino, Renner, Otto, Boisselle, & Sklar, L.L.P., 19th Floor, 1621 Euclid Avenue, Cleveland, OH, 44115, US

(21) Appl. No.: 10/007,512

(22) Filed: Dec. 5, 2001

(30) Foreign Application Priority Data
Dec. 6, 2000 (SG) 200007186-0
Dec. 16, 2000 (SG) 200007449-2

(51) Int. Cl. G06F 15/16; G06F 17/60

(52) U.S. Cl. 709/218; 705/35

(57) ABSTRACT

A real-time financial charting system (10) is described that allows real-time stock market pricing information to be viewed through a browser-only interface on the desktops of Internet users. Historical intraday data (18) and new transaction data (22) “pushed” from a server (12) over the World wide Web are combined and saved as transaction data (20) locally by the client's charting module (16). The computer software charting module on the client computer plots a graph (600) of the real-time financial data. The graph is displayed on the client's computer screen so that the user is able to readily observe changes in the real-time financial data substantially as they occur in a dynamic charting format The system employs HTTP tunnelling that makes it substantially immune to firewalls.

### FIELD OF THE INVENTION

The present invention relates to a method and software capable of providing live real-time graphing of financial data and relates particularly, though not exclusively, to the real-time graphing of stock market financial data using push technology with the data being delivered over the World Wide Web using HTTP tunnelling.

### BACKGROUND TO THE INVENTION

The Internet, and more particularly the World Wide Web (WWW), has become the information medium of the 21st century. The number of people who have access to the Internet and the World Wide Web is growing exponentially in most countries around the world. The present applicants have developed a product tat pushes real-time stock market pricing information through a browser-only interface to the desktops of Internet users. Although there are other similar products available on the Internet, applicants product is the most fully featured, including the advantageous feature of HTTP tunnelling that makes it substantially immune to firewalls. The Bullseye product provides up-to-date pricing information and notifications of stock movement levels based on real-time stock market pricing information obtained from the Stock Exchange. It features a fully configurable stock portfolio, and current market top volumes, top gainer and top loser counters are accessible through a single click of the user's mouse. Further information about the Bullseye product can be obtained from applicant's technology preview website at http://www.bullseye.com.sg.

### SUMMARY OF THE INVENTION

The present invention was developed with a view to providing an enhancement to the Bullseye product by incorporating real-time intraday charting whereby a user can choose to monitor the dynamic intraday chart of a stock. This intraday charting feature enables the user to actually observe the movement on a stock price in a very accurate and timely manner. Although the present invention was developed specifically as an enhancement to the Bullseye product, it will be understood that it may have wider application for the real-time charting of financial information.

Throughout this specification the term “comprising” is used inclusively, in the sense that there may be other features and/or steps included in the invention not expressly defined or comprehended in the features or steps subsequently defined or described. What such other features and/or steps may include will be apparent from the specification read as a whole.

According to one aspect of the present invention, there is provided a method of providing a user with real-time financial charting information on-line, the method comprising the steps of:

obtaining real-time financial data;

transmitting said real-time financial data to a user's computer as a substantially continuous stream through an open connection via a computer network;

generating a graph based on said real-time financial data that is viewable on the user's computer screen; and,

updating said graph based on new real-time financial data transmitted via the computer network whereby, in use, the user is able to readily observe changes in said real-time financial data substantially as they occur in a dynamic charting format.

Preferably said real-time financial data is transmitted via the World Wide Web (WWW) using HTTP protocol.

Preferably the method further comprises the steps of: obtaining and transmitting historical financial data to the user's computer; and, generating said graph using said historical financial data as well as said real-time financial data.

Typically the method further comprises the step of installing a computer software charting module on the user's computer for generating said graph. Preferably said charting module is activated by means of a conventional Internet browser software programme installed on the user's computer. Preferably said charting module runs as a Java applet in the user's computer.

Preferably said real-time financial data is stock market pricing information obtained from a Stock Exchange or other source, and said graph provides real-time intraday charting of movements in stock price.

According to another aspect of the present invention there is provided a computer software charting module for installation on a user's computer, that enables a user to view real-time financial charting information on-line, the module enabling the user's computer to:

receive real-time financial data as a substantially continuous stream through an open connection via a computer network;

generate a graph of said real-time financial data;

update said graph based on new real-time financial data transmitted via the computer network; and

display said graph on the user's computer screen whereby, in use, the user is able to readily observe changes in said real-time financial data substantially as they occur in a dynamic charting format.

Preferably the module further enables the user's computer to: receive historical financial data; and, generate said graph using said historical financial data as well as said real-time financial data.

Preferably the module further enables the user's computer to store said historical data and real-time financial data locally. Advantageously the charting module enables the user's computer to re-scale the axes of the graph in order to ensure that the maximum and minimum values are visible when the graph is displayed on the user's computer screen. Preferably the x-axis of the graph represents time, and the y-axis represents pricing information relating to the stock.

According to a still further aspect of the present invention there is provided a computer-readable storage medium having said computer software charting module stored thereon.

In order to facilitate a better understanding of the nature of the invention a preferred embodiment of the real-time financial charting system will now be described in detail, by way of example only, with reference to the accompanying drawings in which:

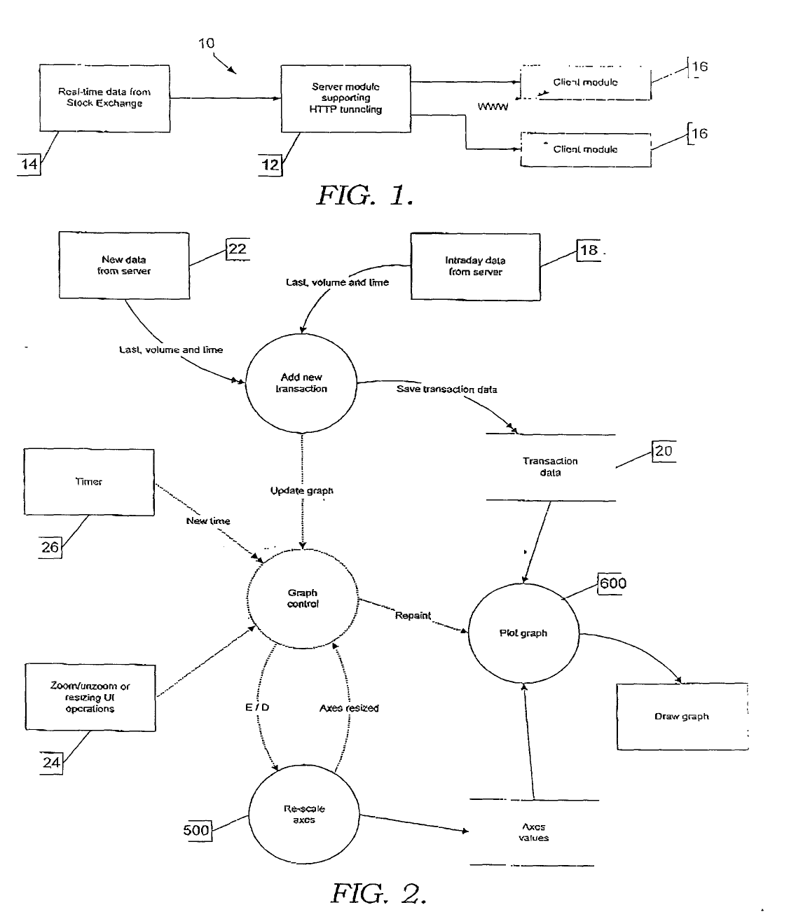

FIG. 1 illustrates schematically the flow of data in a preferred embodiment of the real-time charting system according to the present invention;

FIG. 2 illustrates schematically the flow of data at the client's side in the real-time charting system of FIG. 1;

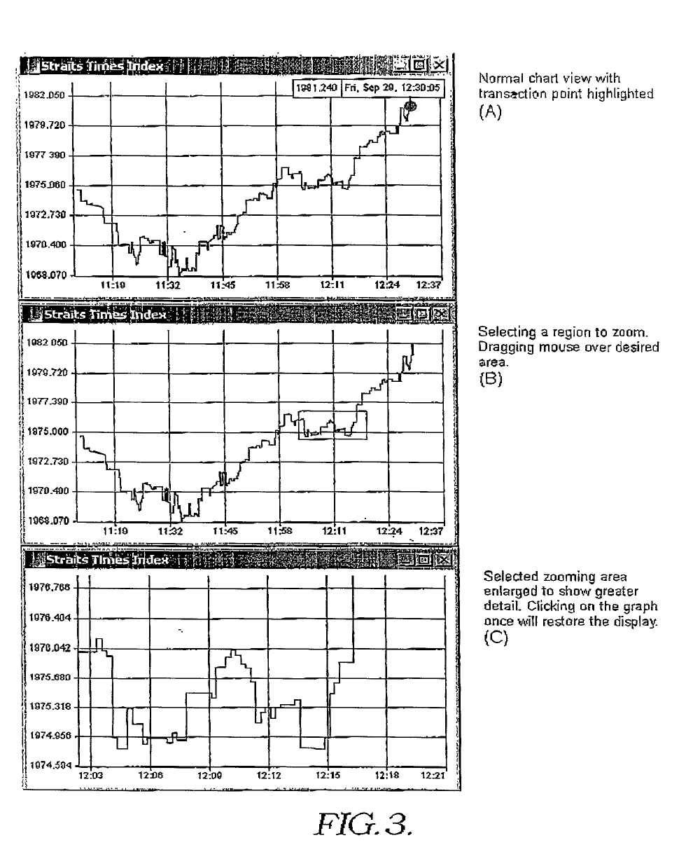

FIGS. 3(a), (b) and (c) illustrate a typical graph viewable on a computer screen at the client's side of the real-time charting system of FIG. 1;

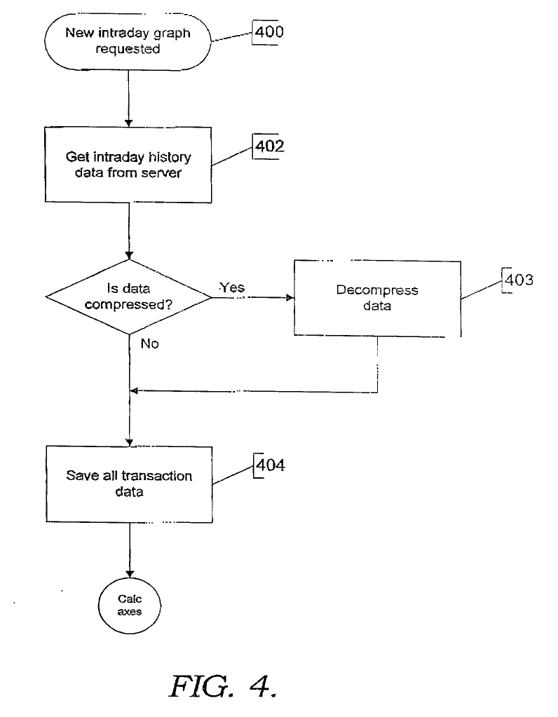

FIG. 4 is a flowchart illustrating the initialisation steps of a computer software charting module employed at the client's side in the real-time charting system of FIG. 1;

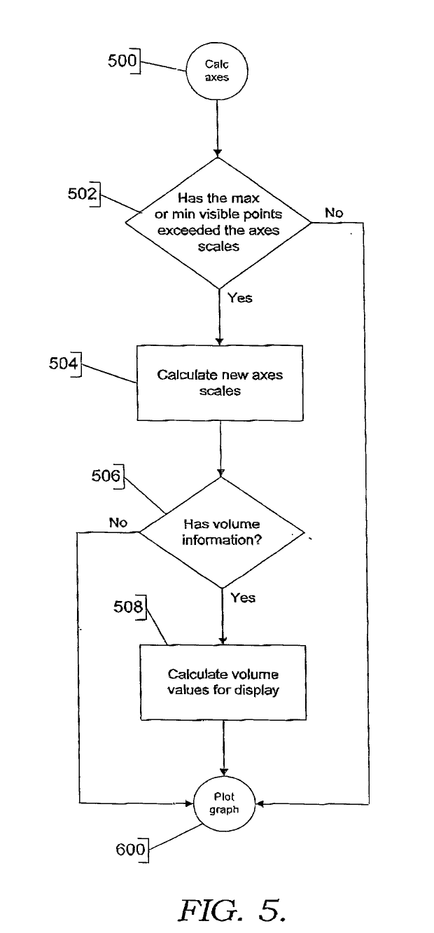

FIG. 5 is a flowchart illustrating a software routine for resizing axes in the charting module of FIG. 4;

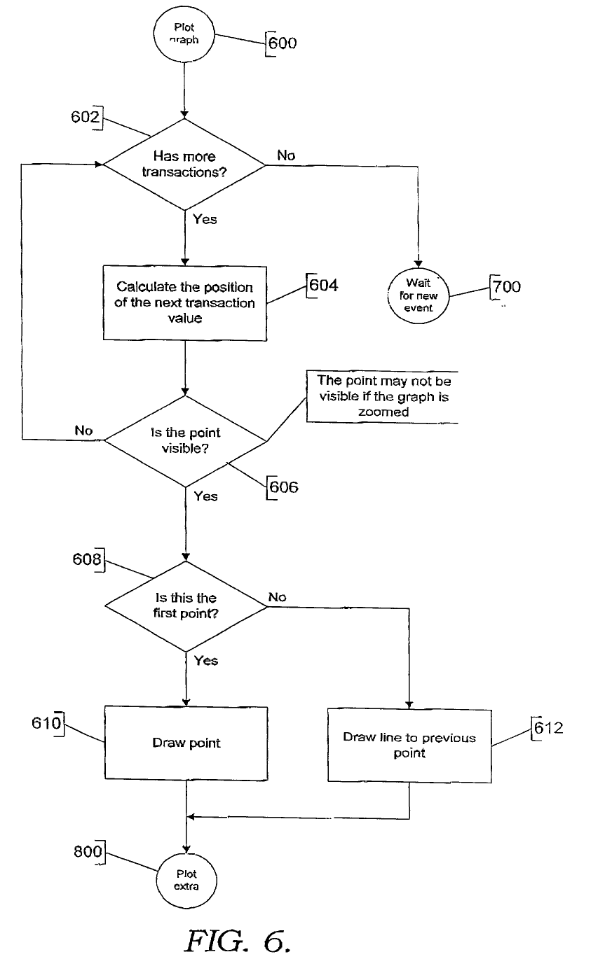

FIG. 6 is a flowchart illustrating a software routine for plotting a graph in the charting module of FIG. 4;

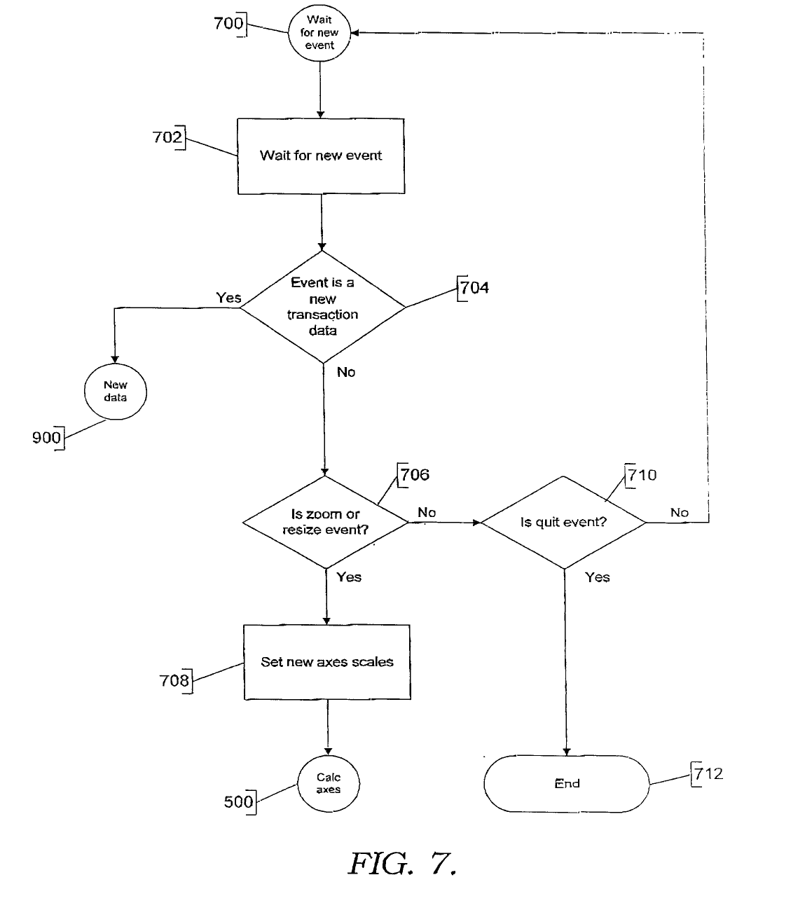

FIG. 7 is a flowchart illustrating a software routine for handling a new event in the charting module of FIG. 4;

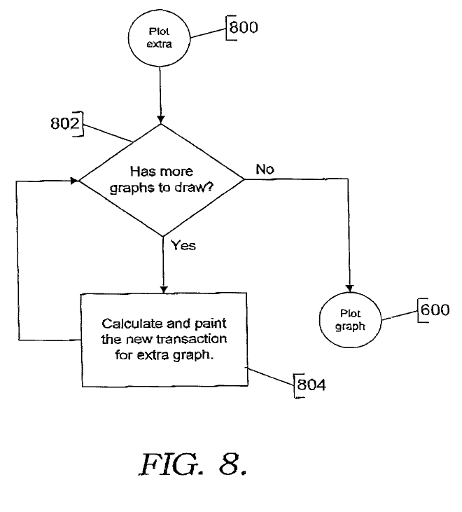

FIG. 8 is a flowchart illustrating a software routine for plotting extra information in the charting module of FIG. 4; and,

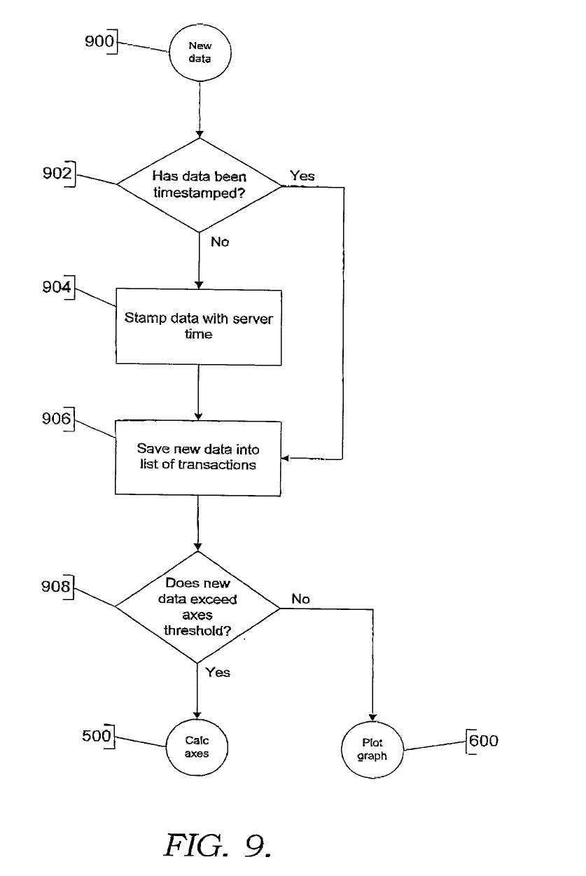

FIG. 9 is a flowchart illustrating a software routine for processing new data in the charting module of FIG. 4.

A preferred embodiment of the real-time charting system 10 in accordance with the present invention includes a server module 12 operating on the service provider's server that obtains real-time financial data 14 in the form of stock market pricing information from the Stock Exchange (or an agent like Reuters). The server module 12 transmits the real-time financial data to one or more client modules 16 over the World Wide Web (WWW) as a substantially continuous stream through an open connection. The server module 12 supports HTTP tunnelling, and hence the communications can go through corporate firewalls on the client's side (it appears to be firewall as if the user is surfing the Internet). HTTP tunnelling is the term used for encapsulating a specific network protocol within packets carried by HTTP protocol. In the present system all two-way client-server communication, including server to client streaming, is embedded in HTTP protocol packets. HTTP is a request/response protocol. The basic steps of a typical HTTP session are a single sequence of the following steps:

1. Client opens connection to the server

2. Client sends request packet

3. Server sends response packet

4. Connection closed

Note that there is one request and one response per connection and they are well ordered. A later version of the protocol (HTTP 1.1) has provisions to pack multiple request/response exchanges through the same connection (persistent connections). The response packet of step 3 may or may not have a content-length header which specifies the length of the response in advance. If there isn't a content-length header then the client knows that the end of the response packet is reached only when the server closes the connection (step 4). This is the reason why sometimes when downloading a file using a browser, the download dialog box states tie length of the file as “unknown”. It means the response packet didn't have the content-length header and the browser will only know that the download is finished when the connection is closed by the server. In the present system, continuos streaming from server to the client is preferably achieved by not specifying the content-length header so that the connection is not closed by the client, and the server keeps transmitting (pushing) the real-time data a part of the response stream (step 4), as and when more data becomes available.

Another way of achieving this would be by specifying a very large value as the content-length such that the connection is “substantially” continuous. In this case the server will keep transmitting until the amount of transmitted data reaches the specified length. Once that happens, the client will immediately initiate a new request/response exchange such that the server can carry on the streaming from the point it left off. The reason for specifying a large value for the content-length in this case is to minimise the frequency of these reconnections as they may cause momentary disruptions to the stream.

Either way, when for one reason or another, the connection to the server is lost, the client automatically initiates a new session (step 1) to resume the streaming. For this, it sends a proper request packet that, among other things, should at least include some sort of a session id such that the server can identify the client and resume the streaming (through the response packet) from the point the connection was lost. Also, every time such a reconnection attempt fails, the client waits for a preset amount of time, and tries reconnecting again until it succeeds or the user terminates the application. This auto reconnection/resume feature makes the streaming robust and self-recovering and it is a significant advantage of the preferred method.

The client module 16 is in the form of a computer software charting module installed on the user's desktop computer for charting incoming data with regards to its price information and the time in which the transaction occurs. The software also provides capabilities to chart the volume of each individual transaction and the weighted average at each point of time. The chart is displayed as a graph in a separate window on the user's computer screen, with the x-axis representing the time of day and the y-axis representing pricing information relating to the stock. The graph is continually being updated and scaled as new data is received from the server module 12 as the seconds pass by. This gives the user the ability to observe the movement on a stock price in real-time in a very accurate and timely manner.

The information plotted within the graph includes its current price value, the volume of the transaction carried out and its weighted average curve. The values are plotted when new data is delivered or at regular time intervals while the stock market is open. For example, if a price change occurs, it is plotted on the graph as soon as it is received. However, if the price remains constant for a set threshold interval of time, at the end of that interval the last received price is plotted automatically so as to keep a continuous flow of updates on the graph. Automatic updates stop upon notification that market trading is closed or suspended. FIG. 3(a) illustrates a typical graph, charting stock market financial data, viewable on the user's computer screen.

The axes of the graph are automatically and continuously scaled as new data is delivered or time progresses, to fit in all points in the graph in an even distribution depending on the size of the graph. Zooming into specific regions of the graph is implemented through a click and drag interface, whereby clicking on the mouse and dragging it while the button is pressed dynamically forms a rectangle that indicates the intended area of interest on the graph. Subsequent release of the button automatically re-scales the axes to draw that area in greater detail. FIG. 3(b) illustrates how a region of the graph may be selected to zoom into using a click and drag movement of the cursor. FIG. 3(c) illustrates the selected zoomed-in region in the graph of FIG. 3(b), with the axes re-scaled to fit the full size of the window frame.

Mouse movement of the cursor is tracked to highlight the closest point in the graph where transactions have occurred. This point is highlighted and the data of the highlighted point is displayed as a pop-up. While tracking, the point to snap to on the graph can be calculated in one of two ways: 1) the point on the graph that has the shortest Euclidean distance to the mouse pointer, or 2) the point on the graph that has the same x co-ordinate as the mouse pointer. In the latter case, it is easier to highlight transactions in the sequence they happened by placing the mouse at a starting point and moving it towards increasing x direction on a straight line.

Dynamic visual cues are provided while the graph is being plotted to easily notify users of specific events and important information. For example, when the price remains constant for a period a straight line is being drawn. However, once a change occurs, then depending on the change being upwards or downwards, a respective green or red circle is flashed to highlight the advancing end of the graph (see FIG. 3(a)). While the pricing information is being plotted on the main graph, other technical analysis graphs such as Bollinger Bands, Moving Average Convergence/Divergence (MACD), Relative Strength Indicators (RSI), etc, can be drawn simultaneously, either overlapped on the same graph area or as separate graphs, to help the user make instant buy/sell decisions.

The window within the intraday graph is displayed can be scaled in the same manner as any other window (scaling the window, scales the graph as well). The user can zoom into any area of the graph, and there is practically no lower limit to the granularity (it is possible to zoom in to the extent that the whole x-axis covers only a fraction of a second).

Operation of the computer software charting module 16 stored on the user's desktop computer will now be described in detail with reference to FIG. 2 and FIGS. 4 to 9. The charting module is a browser-only software application, in the sense that it runs as a Java 1.1 applet on the client's side which is supported by all common browsers, such as Microsoft Explorer® and Netscape Navigator®. Therefore, the user does not have to install any other software programme on their desktop computer. Indeed, the charting module itself can be delivered to the user's desktop computer via the World Wide Web.

Data is delivered from tie server to the client based upon what is commonly referred to as a push model of data broadcasting, ie. the graph is being drawn as the data flows in without the interaction of the user. Each client is responsible for subscribing to the stock market counters that it wishes to receive data for. The server maintains a subscription list of which to send updated information to. New data is broadcast judiciously and only when a relevant change has occurred. FIG. 2 illustrates the flow of data on the client's side as controlled by the charting module. Upon launching of a new graph by the user, the client subscribes the new counter with the server and proceeds to request the counter's historical intraday data 18 up to the instant the server receives the request. This is illustrated at 400 and 402 in FIG. 4. Historical intraday data is sent to the client as a continuous block of data and is parsed by the client. Preferably historical data is streamed to the client in compressed format. If it is compressed, the module instructs the user's computer to decompress it at 403 to obtain the block of transaction data before passing it on. This transaction data 20 is then saved on the user's computer (step 404 in FIG. 4).

Subsequently, new near-real-time data 22 for plotting the graph is delivered from the server as a common data record which is used by all client components of the charting module. The data is propagated amongst all components which handle the data including the table, graph and alert components. There may not be timing information associated with each transaction data delivered from the server. The charting module determines whether the data has been time stamped at 902 (see FIG. 9), and if not, that data is time stamped at 904 with an approximation of the server's time. The new transaction data is then added to the historical intraday data and saved into the list of transaction data 20 at 906. The charting module determines at 908 whether either axes has been exceeded, or is about to be exceeded, by the value of the new transaction data. If so, the graph is re-scaled by the charting module at 500 (see FIG. 5). The graph axes are re-scaled and the transaction data re-plotted whenever the values of the transaction data exceed the axes scales, when user zoom 24 (see FIG. 2) occurs or when the graph frame itself is re-sized. The re-scaling sub-routine of the charting module determines whether the maximum or minimum visible points exceed the axes scales at 502. If so, new axes scales are calculated at 504. The charting module also determines whether the volume of the transaction carried out is included with the transaction data at 506, and if so calculates the volume values for display at 508. The charting module then proceeds to plot the graph at 600 (see FIG. 6).

The graph plotting sub-routine of the charting module illustrated in FIG. 6 firstly determines at 602 whether any new transaction data has been received and stored locally. If no new data has been received, it waits for a new event at 700 (see FIG. 7). If new transaction data has been received it calculates the position of the next transaction value at 604. New plot points are added to the graph as a result of one of the following two events:

(1) A new transaction value is received from the server; or

(2) A timer unit 26 (see FIG. 2) notifies that a predetermined threshold time interval has passed without receiving any new transaction data from the server. If (2) occurs, the last value received from the server is deemed to be unchanged and drawn again. This is to maintain the, real-time updating aspect of the graph with respect to the time axis. When the position of Me next point in the graph has been calculated, the sub-routine determines at 606 whether the point is visible on the axis as currently scaled. If not, the axes are re-scaled at 500 (see FIG. 5).

If the sub-routine determines that this is the first point at 608, it draws the point on the graph at 610. If it is not the first point, it draws a line between the new point and the previous point at 612. The sub-routine determines whether there are extra graphs to draw and if so proceeds to plot the additional graphs at 800 (see FIG. 8). As shown in FIG. 8, if there are extra graphs to draw, such as Relative Strength Indicators (RSI), the charting module applies the respective formulae to the standard price data and produces a representation of this information at 804 that may be viewable on the graph or plotted as a separate graph. If no additional graphs are present, the charting module continues to plot the graph at 600, as per the sub-routine illustrated in FIG. 6.

While no new transaction data is being received, the charting module monitors the situation for the occurrence of any new event at 702 (see FIG. 7). If the module determines that the new event is the reception of new transaction data at 704, it handles the new data as per the sub-routine illustrated in FIG. 9. If the new event is activation of the zoom function or frame resizing function as determined at 706, the charting module sets new axes scales at 708 as per the axes calculation sub-routine 500 illustrated in FIG. 5. If the user requests to quit the charting module at 710 it closes the graph window and shuts itself down at 712.

Now that a preferred embodiment of the real-time financial charting system 10 has been described in detail, it will be apparent that it provides a number of significant advantages, including the following:

i) it is a browser-only solution, so that the user does not have to store any other software on their computer;

ii) it employs push technology, so that the graph is drawn continuously as the data flows in without the user having to do anything;

(iii) by using HTTP tunnelling, it is substantially transparent to corporate firewalls;

(iv) the intraday graph can be fully scaled and the user can zoom into any area of the graph;

(v) it gives the user the ability to actually observe the movement on a stock price in real-time in a very accurate manner;

(vi) it allows other technical analysis besides price data to be presented in a user-friendly manner, helping the user make instant buy/sell decisions;

(vii) visual cues can be provided to quickly notify users of specific events and important information. These include trend indicators to signify at a glance the current price movement of the counter being charted.

It will be apparent to persons skilled in the financial services and computer software arts that numerous variations and modifications may be made to the real-time financial charting system, in addition to those already described, without departing from the basic inventive concepts. For example, the charting module may include facility to allow the user to customise the way in which the graph is displayed on the user's computer screen. All such variations and modifications are to be considered within the scope of the present invention, the nature of which is to be determined from the foregoing description and the appended claims.

The claims defining the invention

1. A method of providing a user with real-time financial charting information on-line, the method comprising the steps of:
obtaining real-time financial data;
transmitting said real-time financial data to a user's computer as a substantially continuous stream through an open connection via a computer network;
generating a graph based on said real-time financial data that is viewable on the user's computer screen; and,
updating said graph based on new real-time financial data transmitted via the computer network whereby, in use, the user is able to readily observe changes in said real-time financial data substantially as they occur in a dynamic charting format.

2. A method of providing a user with real-time financial charting information on-line as defined in claim 1, wherein said real-time financial data is transmitted via the world Wide Web (WWW) using HTTP protocol.

3. A method of providing a user with real-time financial charting information on-line as defined in claim 2, wherein substantially continuous streaming of the real-time financial data is achieved by not specifying a content-length header in the HTTP response packet, so that the connection is not closed by the user's computer and transmission of said financial data continues as and when more data becomes available.

4. A method of providing a user with real-time financial charting information on-line as defined in claim 2, wherein substantially continuous streaming of die real-time financial data is achieved by specifying a reasonably large value as the content-length of the HTTP response packet, such that transmission of said financial data continues until the amount of transmitted data reaches the specified length whereupon a new request/response exchange is initiated such that streaming of said financial data can carry on from the point it left off.

5. A method of providing a user with real-time financial charting information on-line as defined in claim 1, wherein the method further comprises the steps of: obtaining and transmitting historical financial data to the user's computer; and, generating said graph using said historical financial data as well as said real-time financial data.

6. A method of providing a user with real-time financial charting information on-line as defined in claim 5, wherein said historical data is compressed prior to transmission and decompressed after it is received at the user's computer.

7. A method of providing a user with real-time financial charting information on-line as defined in any one of claims 1 to 6, wherein the method further comprises the step of installing a computer software charting module on the user's computer for generating said graph.

8. A method of providing a user with real-time financial charting information on-line as defined in claim 7, wherein said charting module is activated by means of a conventional Internet browser software programme installed on the user's computer.

9. A method of providing a user with real-time financial charting information on-line as defined in claim 8, wherein said charting module runs as a Java applet in the user's computer.

10. A method of providing a user with real-time financial charting information on-line as defined in claim 7, wherein said real-time financial data is stock market pricing information obtained from a Stock Exchange or other source, and said graph provides real-time intraday charting of movements in stock price.

11. A computer software charting module for installation on a user's computer, that enables a user to view real-time financial charting information on-line, the module enabling the user's computer to:
receive real-time financial data as a substantially continuous stream through an open connection via a computer network;
generate a graph of said real-time financial data;
update said graph based on new real-time financial data transmitted via the computer network; and
display said graph on the user's computer screen whereby, in use, the user is able to readily observe changes in said real-time financial data substantially as they occur in a dynamic charting format.

12. A computer software charting module as defined in claim 11, wherein the module further enables the user's computer to: receive historical financial data; and, generate said graph using said historical financial data as well as said real-time financial data.

13. A computer software charting module as defined in claim 12, wherein the module further enables the user's computer to store said historical data and real-time financial data locally.

14. A computer software charting module as defined in claim 11, wherein the charting module enables the user's computer to re-scale the axes of the graph in order to ensure that the maximum and minimum values are visible when the graph is displayed on the user's computer screen.

15. A computer software charting module as defined in claim 14, wherein the x-axis of the graph represents time, and the y-axis represents real-time stock market pricing information relating to specified stock obtained from the Stock Exchange or other source whereby, in use, said graph provides real-time intraday charting of movements in stock price.

16. A computer software charting module as defined in claim 15, wherein the module re-scales the x-axis according to the time of day such tat the graph extends to the full extent of the graph area.

17. A computer software charting module a defined in claim 13, wherein the module enables zooming into specific regions of the graph trough a click and drag interface, whereby clicking on the user's computer mouse and dragging it while the button is pressed dynamically forms a rectangle indicating the intended zoom area, and subsequent release of the button results in automatic re-scaling of the axes to draw said zoom area in greater detail.

18. A computer software charting module as defined in claim 15, wherein the module calculates and/or plots other technical analysis graphs, such as Bollinger Bands, Moving Average Convergence/Divergence (MACD) and Relative Strength Indicators (RSI), simultaneously while the pricing information is being plotted on a main graph.

19. A computer software charting module as defined in claim 15, wherein the module provides dynamic visual cues while the graph is being generated to easily notify the user of specific events and important information.

20. A computer software charting module as defined in claim 15, wherein the module enables mouse movement of the cursor on the user's computer screen to be tracked, highlights the closest point in the graph to the cursor where transactions have occurred and displays the data of the highlighted point.

21. A computer-readable storage medium having a computer software charting module as defined in any one of claims 11 to 20 stored thereon.
